(19) United States
(12) Patent Application Publication
(10) Pub. No.: US 2002/0019728 A1
(43) Pub. Date: Feb. 14, 2002

(54) Frequency domain variogram computation and mapping

(76) Inventors: Peter P. Van Bemmel, Houston, TX (US); Feng P. Ruan, Oslo (NO)

Correspondence Address: Schlumberger Geoquest, Suite 1700, 5599 San Felipe, Houston, TX, 77056-2722, US

(21) Appl. No.: 09/911,287

(22) Filed: Jul. 23, 2001

Related U.S. Application Data
(60) Provisional application No. 60/221,462, filed on Jul. 26, 2000.

(51) Int. Cl. G06F 17/10

(52) U.S. Cl. 703/2

(57) ABSTRACT

A Semi-Variogram is generated by taking the Fourier Transform of ‘spatial data in the space domain’ thereby producing a frequency domain representation of the spatial data having a DC component (equivalent to a mean of the spatial data), removing the DC component to produce the frequency domain representation of the spatial data with zero mean (FFT), computing the complex conjugate of FFT (FFT*), complex multiplying FFT and FFT* to produce a complex product, taking the inverse Fourier Transform of the complex product to produce a space domain representation of the complex product (IFFT), and subtracting IFFT from the zero lag covariance to generate a Semi-Variogram. This Abstract is given for the sole purpose of allowing a patent searcher to easily determine the content of the disclosure in this specification.

### CROSS REFERENCE TO RELATED APPLICATIONS

This application is a Utility application of prior pending Provisional application Ser. No. 60/221,462 filed Jul. 26, 2000.

### BACKGROUND OF THE INVENTION

The subject matter of the present invention relates to a geostatistical method of modeling a discrete field of a random variable from observed regularly or sparsely positioned data values.

As noted above, the subject matter of the present invention relates to a geostatistical method of modeling a discrete field of a random variable from observed regularly or sparsely positioned data values. An example of this technique is the estimation of the concentration of copper ore over an area of a square mile and a depth of three hundred feet based on core samples taken at hundred foot intervals and to a depth of three hundred feet. Such an estimation is based on interpolation of the expected value and the variance that are derived from the observed data. The technique is known as kriging after the South African explorer D. G. Krige (5-Krige), lucidly expounded by A. G. Journel (1-Journel).

One prerequisite for this technique is that the variance and the correlation length of the data are known. These parameters may be obtained from the data by computing a diagnostic function known as the semi-variogram. In order to compute this semi-variogram, the data is correlated with itself at different lag distances. At each lag distance, the sum is calculated of all the products of the data samples (diminished by the mean) that coincide in space and then subtracting this number from the zero lag variance of the same data.

The semi-variogram of a discrete random variable at a lag distance of ‘h’ (2-Deutsch, page 13) can be expressed as follows:

γₕ=c₀−cₕ, ∀u (1)

and the covariance can be expressed as follows:

cₕ=E{zᵤ₊ₕzᵤ}−[E{zᵤ}]², ∀u, u+hεA (2)

where:

γₕ=semi-variance as a function of h

c₀=zero lag covariance (variance)

E{ }=expected value of

zᵤ=random variable

u=space index

h=lag distance

∀=for all

ε=element of

A=area under consideration

The current, prior art method of generating the semi-variogram is computationally intensive and becomes cumbersome with the sizable earth models that are dealt with in the petroleum industry. The process time on a single CPU computer increases proportionally with the power 2 of the cumulative product of m nₘ where m is the number of dimensions of the problem and n the number of data in each dimension.

Refer to a book entitled “Geostatistics”, by A. Royle, Isobel Clark, P. I. Brooker, H. Parker, A. Journel, J. M. Rendu, and Pierre Mousset-Jones, published by McGraw Hill, Inc, New York, New York, copyright 1980, the disclosure of which is incorporated by reference into this specification. See, in particular, chapter 2 of that book entitled “Part 1, the Semivariogram”, pages 17-40.

The advent of the Fourier Transform as an application in digital filtering has revolutionized the seismic signal processing industry. Specifically the technique of seismic data migration for the purpose of imaging the subsurface of the earth is applied as a matter of course in the frequency domain. In particular the invention of the Fast Fourier Transform (FFT) by Tukey and Cooley (3-Oppenheim, ch 6) has proved a tremendous success. By utilizing the symmetry of the binary number system the CPU cycle time for 2 an n×n matrix may be reduced to nlog₂n rather than n², provided n is a power of two. For the migration of a two dimensional data set of 1024 traces with 1024 samples each a reduction factor of two orders of magnitude may be achieved.

### SUMMARY OF THE INVENTION

The novel method of the present invention includes the step of: in response to a plurality of spatial data in the space domain, using a Fast Fourier Transform to generate a “Semi-Variogram”. The method of the present invention is not restricted to data numbers of a power of two, nor to uniform sampling.

Further scope of applicability of the present invention will become apparent from the detailed description presented hereinafter. It should be understood, however, that the detailed description and the specific examples, while representing a preferred embodiment of the present invention, are given by way of illustration only, since various changes and modifications within the spirit and scope of the invention will become obvious to one skilled in the art from a reading of the following detailed description.

### BRIEF DESCRIPTION OF THE DRAWINGS

A full understanding of the present invention will be obtained from the detailed description of the preferred embodiment presented hereinbelow, and the accompanying drawings, which are given by way of illustration only and are not intended to be limitative of the present invention, and wherein:

FIG. 1 illustrates a family of semi-varogram curves in different horizontal directions through the data space.

FIG. 2 illustrates the anisotropic ellipse of the radius of influence (or correlation distance) in all horizontal directions through the data space.

FIG. 3 illustrates a variogram map with the ellipse of the radius of influence superimposed. The x and y axes are the x- and y-lag distances from -Nh through +Nh. The color code indicates the magnitude of the semi-variogram for each combination of x and y lag distance. Such a map is called a variomap (2-Deutsch, p55).

FIGS. 4 and 5 illustrate the covariance function obtained by summing FFT covariance maps computed at different levels of a 3D data cube. The witches hat display is a 3D rendering where the x and y axes are the x- and y-lag distances from −Nh through +Nh. In FIG. 4 the z-axis indicates the magnitude of the covariance for each combination of x and y lag distance. In FIG. 5 the color code indicates the magnitude of the covariance for each combination of x and y lag distance.

FIG. 6 illustrates an xz cross-section and xy plan view of a cube of data representing a simulated distribution of a random variable.

FIG. 7 is a perspective drawing of a random data sample obtained from the cube in FIG. 6 by a Monte Carlo technique in four controlled zones. The sampling rate is 0.5 percent, of which four equal parts are taken in each of three internal boxes and in the entire cube. Inside the data cloud is the ellipsoid obtained by FFT variomapping showing the three principal axes of the radius of influence.

FIG. 8 is the result of Kriging (1-Journel) based on the random sample in FIG. 7 and the variogram analysis using FFT variomapping.

FIG. 9 illustrates a workstation and a CD which stores the Semi-Variogram generation software of the present invention;

FIG. 10 illustrates the ‘spatial data in the space domain’.

FIG. 11 illustrates a block diagram of the Semi-Variogram generation software 12 of the present invention.

FIGS. 12A and 12B illustrate a more detailed construction of the Semi-Variogram generation software 12 of the present invention.

### DETAILED DESCRIPTION OF THE INVENTION

In order to facilitate a thorough understanding of the present invention, the ‘Detailed Description of the Invention’ section of this specification will include two parts:

(1) a ‘General Discussion of the Invention’ and (2) a ‘Detailed Discussion of the Invention’.

General Discussion of the Invention

Semi-variograms are primarily used in mapping of mineral or hydrocarbon deposits from a sufficient number of discrete samples. It is common practice to compute the semi-variograms by a two point correlation between pairs of data samples separated by an ever increasing lag distance. This method is compute intensive and becomes cumbersome for large sized problems. The present invention utilizes the computational speed of the Fast Fourier Transform to improve the computational requirements for the semi-variogram by several orders of magnitude, dependent on the size of the problem.

It can be demonstrated that the semi-variogram is the zero lag covariance (variance) complement of the covariance function. This in turn leads to the realization that the semi-variogram may be derived from the covariance function itself, which is a correlation in the space domain. The equivalent of this operation is the convolution of the function with the space reversed version of itself. It is well known that convolution in the space domain is equivalent to complex multiplication in the frequency domain.

Hence, the novel method of the present invention for generating a “Semi-Variogram” comprises the following steps:

(1) Convert the data series from space to frequency by the Fourier Transform (FFT)

(2) Remove the DC component

(3) Compute the complex conjugate by negating the phase (FFT*)

(4) Complex multiply the FFT and the FFT*

(5) Inverse Fourier Transform the result (IFFT)

(6) Subtract the IFFT from C₀

This method can be extended to the computation of a semi-variogram map, that is, a two dimensional Fast Fourier Transform (2DFFT) is used in connection with a two dimensional (2D) grid of data. The result is a map that shows the variogram value in all directions, and with a point of symmetry at its center. Should the data be anisotropic in the 2D (xy) domain, then this will show up as elliptical contours of like values centered about the middle of the map. The azimuth of this anisotropy as well as the magnitude of the large and small axes can all be measured from this map.

To obtain the average semi-variogram map for a cube of data this operation may be repeated for all z-levels and vertically averaged. A similar result may be obtained on scattered data by carrying out the FFT on a sparsely filled grid, where the scatter data has been placed at the nearest grid intersection.

The above referenced novel method of the present invention, for generating a Semi-Variogram, is applicable to any number of dimensions. For example, the novel method is applicable to 3-dimensions (3D) by applying a three-dimensional Fast Fourier Transform (3D FFT) on a multi-layered grid. In doing so, the secondary anistropy as well as the dip and plunge of the ellipsoid may be measured from the 3D semi-variogram cube.

Detailed Discussion of the Invention

It is common practice to compute semi-variograms by a two point correlation between pairs of data samples separated by an ever increasing lag distance (1-Journel).

It can also be demonstrated that the semi-variogram is the zero lag covariance (variance) complement of the covariance function. This in turn leads to the realization that the semi-variogram may be derived from the covariance function itself, which is an autocorrelation in the space domain. The equivalent of this operation is the convolution of the function with the space reversed version of itself. It is well known (4-Papoulis, p 26), that convolution in the space domain is equivalent to complex multiplication in the frequency domain.

Hence, the operation or novel method steps of the present invention for generating a Semi-Variogram may be executed for a regularized orthogonal discrete variable in any direction through the space occupied by the variable. Thus, the novel method steps of the present invention, for generating a Semi-Variogram, comprises the steps of:

(1) Compute the frequency domain representation of the variable using the Fast Fourier Transform (FFT)

(2) Remove the DC component

(3) Compute the complex conjugate of the variable by negating the phase (FFT*)

(4) Complex multiply the FFT and the FFT*

(5) Inverse Fourier Transform the result (IFFT)

(6) Subtract the IFFT from C₀

The result is a one-dimensional semi-variogram representing the correlation distance and the variance in the discrete variable of the analysis, for the direction in which the lag distance was taken.

The semi-variogram of a discrete random variable can be expressed as follows:

γₕ=c₀−cₕ, ∀u (1)

The Covariance function is an auto-correlation in the space domain, as follows:

cₕ=E{zᵤ₊ₕzᵤ}−[E{zᵤ}]², ∀u, u+hεA=Σᵤ{zᵤ₊ₕzᵤ}/n−Σᵤ{zᵤ}²/n (2)

This is a convolution with the complex conjugate in the frequency domain:

Z_{ω}=FTzᵤ (3)

C_{ω}=Z_{ω}·Z_{ω}* (4)

where:

γh=semi-variance as a function of h

c₀=zero lag covariance (variance)

E{ }=expected value of

zᵤ=random variable

u=space index

h=lag distance

∀=for all

Z_{ω=Fourier Transform of z}ᵤ

FT=Fourier Transform

Z_{ω}*=Complex conjugate of Z_{ω}

ε=element of

A=area under consideration

This method can be extended to the computation of a “semi-variogram map” or a “variomap” (2-Deutsch, p 55). This map may be constructed by taking distance lags in all directions in an arbitrary plane through the data space (plane of analysis), and accumulating the results as a function of lag distance. The result is a map that shows the variogram value in all directions in the plane of analysis, and with a point of symmetry at its center. Should the data be anisotropic in the 2D (xy) domain, then this will show up as elliptical contours of like values centered about the middle of the map. The azimuth of this anisotropy as well as the magnitude of the large and small axes can all be measured from this map.

Again the same results may be obtained much quicker by performing a two dimensional Fast Fourier Transform (2D FFT) on a two dimensional (2D) grid of data. To obtain the average semi-variogram map for a horizontal plane of analysis through a cube of data, this operation may be repeated for all z-levels and vertically averaged.

A similar result may be obtained on scattered data by carrying out the Fourier Transform (FT) on a sparsely filled grid, where the scatter data has been regularized to the nearest grid intersections.

For scattered data, the results need to be normalized by the number of “hits” that is registered at every lag position. The number is never greater than that for zero lag, and vastly smaller than that at all other lag positions for sparsely populated grids. The normalization grid may be obtained by placing a value of unity at each grid location occupied by a data value. The same technique used for the computation of the ‘variomap’ may be utilized to get the normalizer grid representing the number of elements contributing to the variomap. The final result is obtained by dividing the FFT variomap by the FFT normalizer map whereever a non-zero value is present.

The method is applicable to any number of dimensions. For example, this method is applicable to three dimensions (3D) by applying a Three Dimensional Fast Fourier Transform (3D FFT) on a multi-layered grid. In doing so, the secondary anistropy as well as the dip and plunge of the ellipsoid may be measured from the 3D semi-variogram cube.

When the novel method steps of the present invention, for generating a Semi-Variogram, are executed by a processor of a workstation, the following ‘results’ can be visualized in the following figures of drawing.

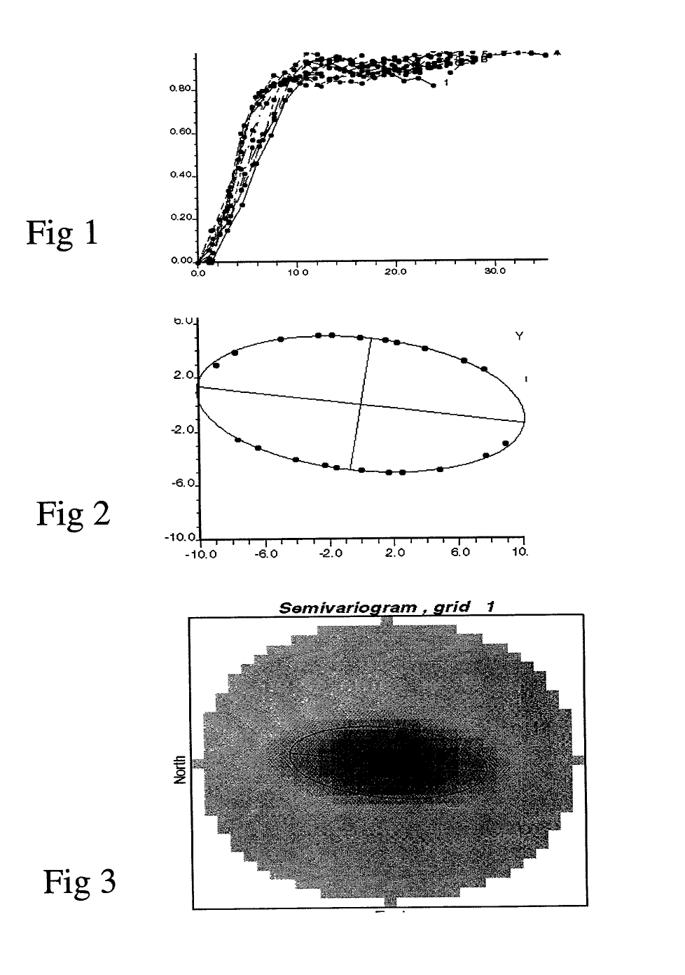

Refer now to FIGS. 1 through 8.

In FIG. 1, a family of semi-varogram curves is illustrated in different horizontal directions through the data space.

In FIG. 2, the anisotropic ellipse of the radius of influence (or correlation distance) is illustrated in all horizontal directions through the data space.

In FIG. 3, a variogram map (variomap) is illustrated with the ellipse of the radius of influence superimposed. The x and y axes are the x- and y-lag distances from −Nh through +Nh. The color code indicates the magnitude of the semi-variogram for each combination of x and y lag distance.

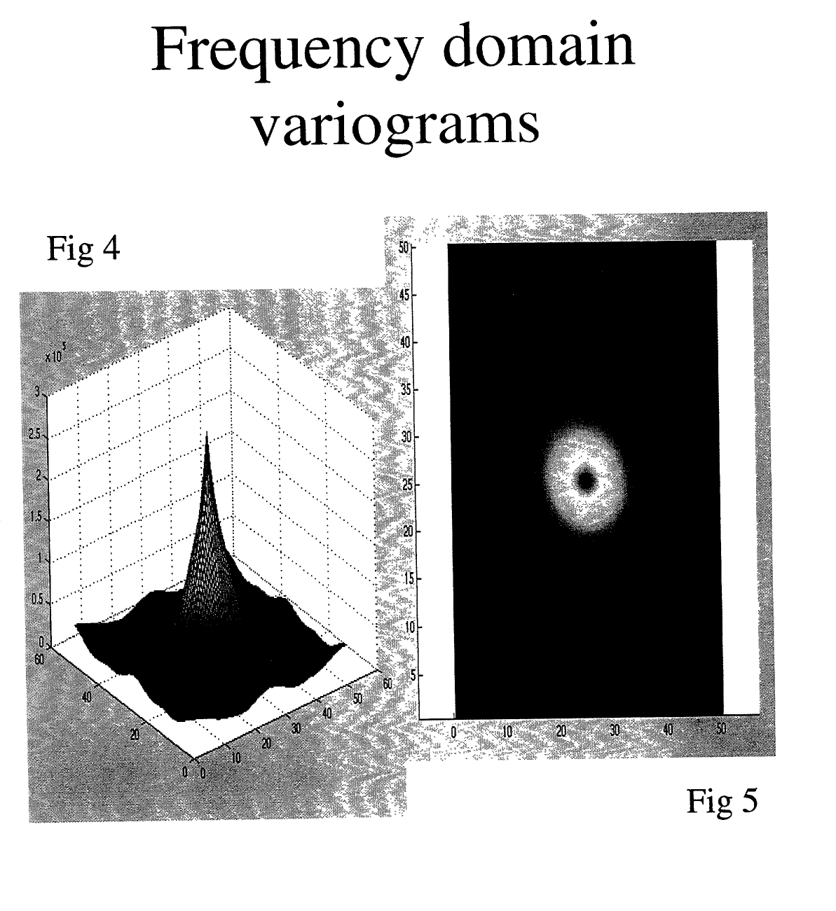

In FIGS. 4 and 5, the covariance function, obtained by summing FFT covariance maps calculated at different levels of a 3D data cube, is illustrated. The ‘witches hat’ display is a 3D rendering where the x and y axes are the x- and y-lag distances from −Nh through +Nh. In FIG. 4, the z-axis indicates the magnitude of the covariance for each combination of x and y lag distance. In FIG. 5, the color code indicates the magnitude of the covariance for each combination of x and y lag distance.

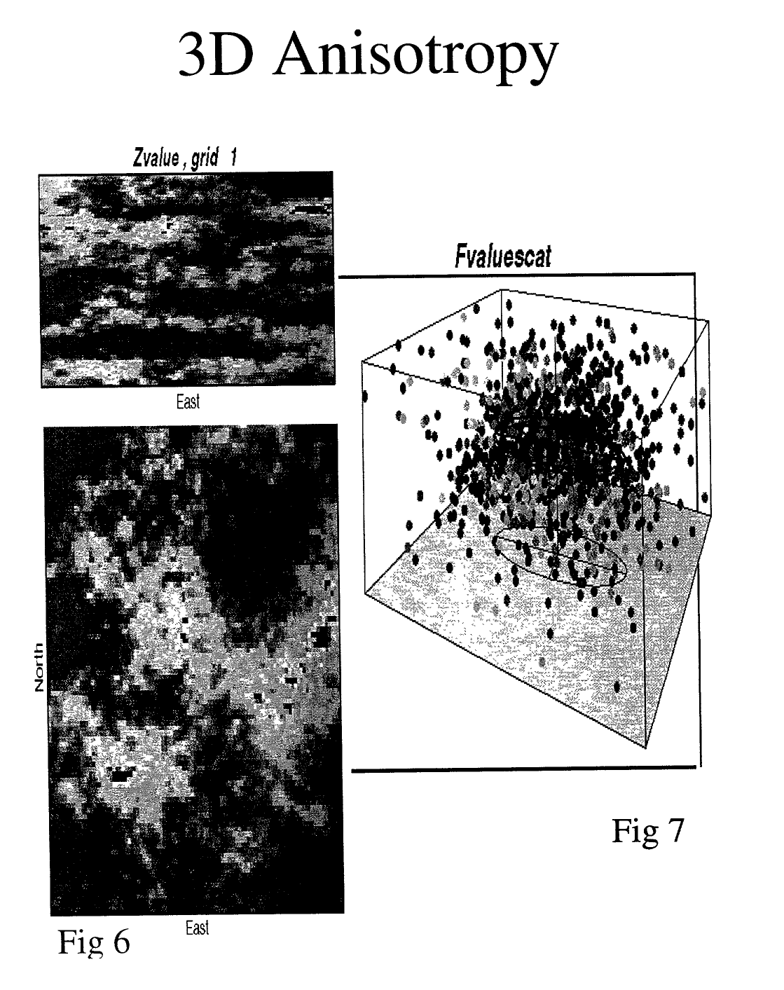

In FIG. 6, an xz cross-section and xy plan view of a cube of data is illustrated representing a simulated distribution of a random variable.

In FIG. 7, a perspective drawing of a random data sample is illustrated which was obtained from the cube in FIG. 6 by a Monte Carlo technique in four controlled zones. The sampling rate is 0.5 percent, of which four equal parts are taken in each of three internal boxes and in the entire cube. Inside the data cloud, see the ellipsoid which was obtained by Fast Fourier Transform (FFT) variomapping showing the three principal axes of the radius of influence.

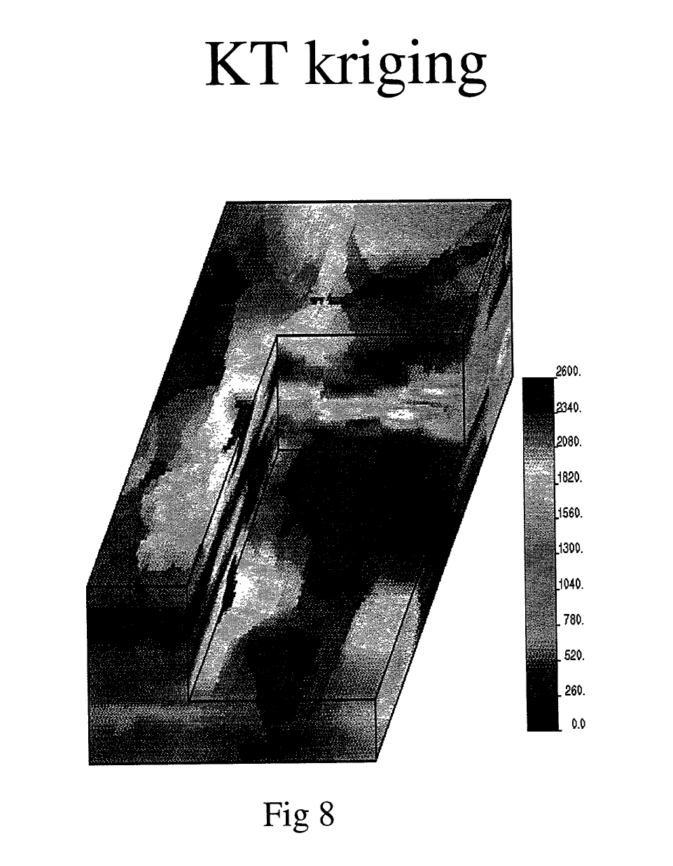

In FIG. 8, a ‘result’ is illustrated, which is the result of Kriging (1-Journel) based on: (1) the random sample in FIG. 7, and (2) the variogram analysis using Fast Fourier Transform (FFT) variomapping.

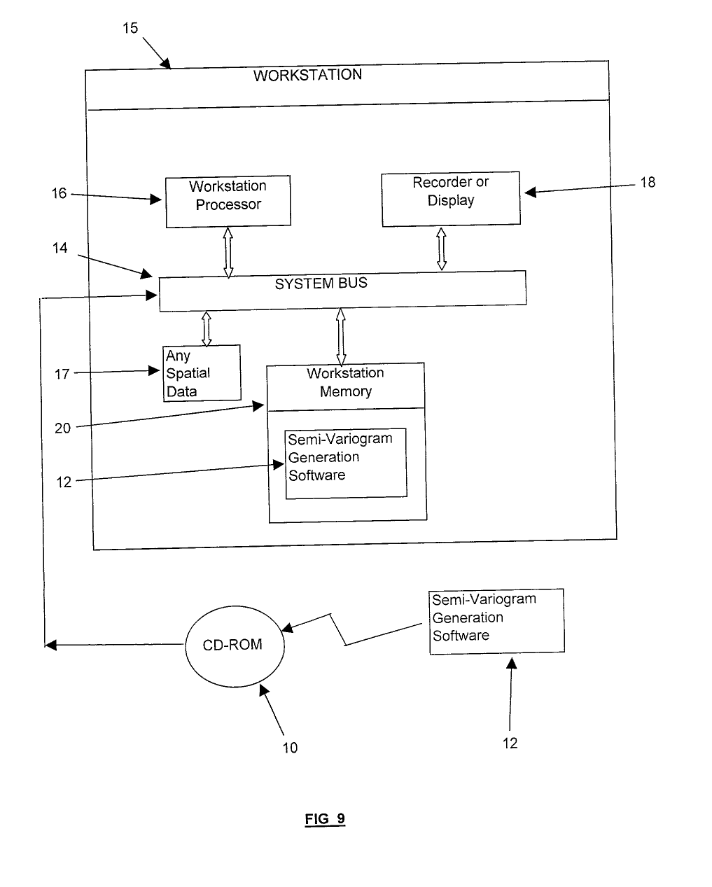

Referring to FIG. 9, a workstation 15 is illustrated. The workstation 15 includes a workstation processor 16 connected to a system bus 14, a recorder or display 18 connected to the system bus 14, and a workstation memory 20 connected to the system bus 14. Input data is provided to the workstation 15, and, in FIG. 9, that input data is called ‘Any Spatial Data’ 17, since any type of spatial data can be utilized in connection with the present invention. In the memory 20, a software package known as the ‘Semi-Variogram Generation Software’ 12 is stored in the memory 20 of the workstation 15. The Semi-Variogram Generation Software 12 was previously loaded into the memory 20 from a CD-ROM 10, since the Semi-Variogram Generation Software 12 is stored on the CD-ROM 10. In operation, when the workstation processor 16 uses any spatial data 17 during the execution of the Semi-Variogram Generation Software 12, a Semi-Variogram, of the types illustrated in FIGS. 1 through 3, is displayed on the Recorder or Display 18.

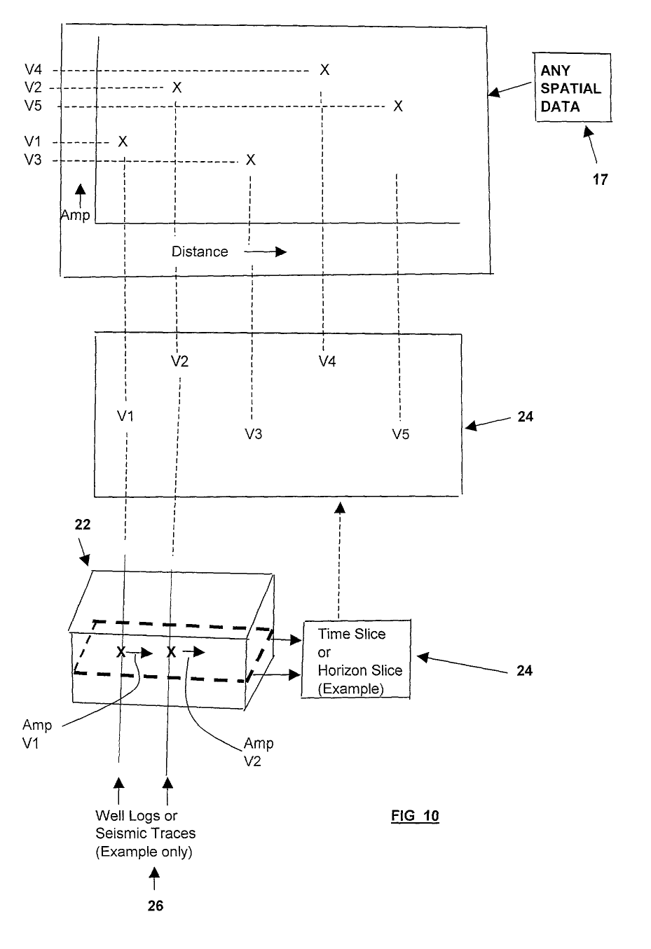

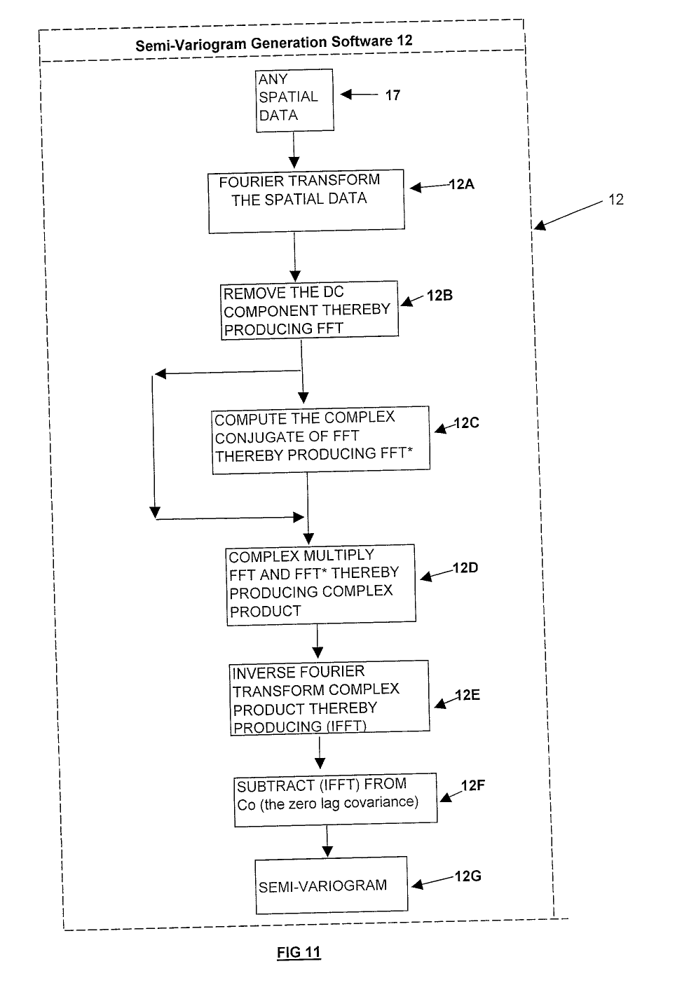

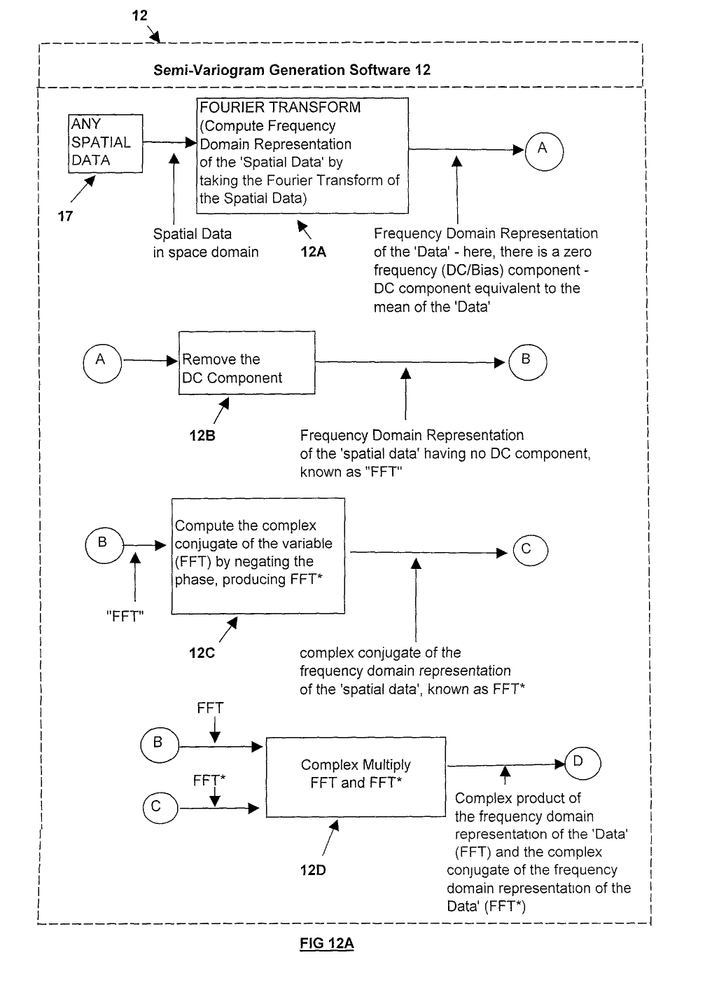

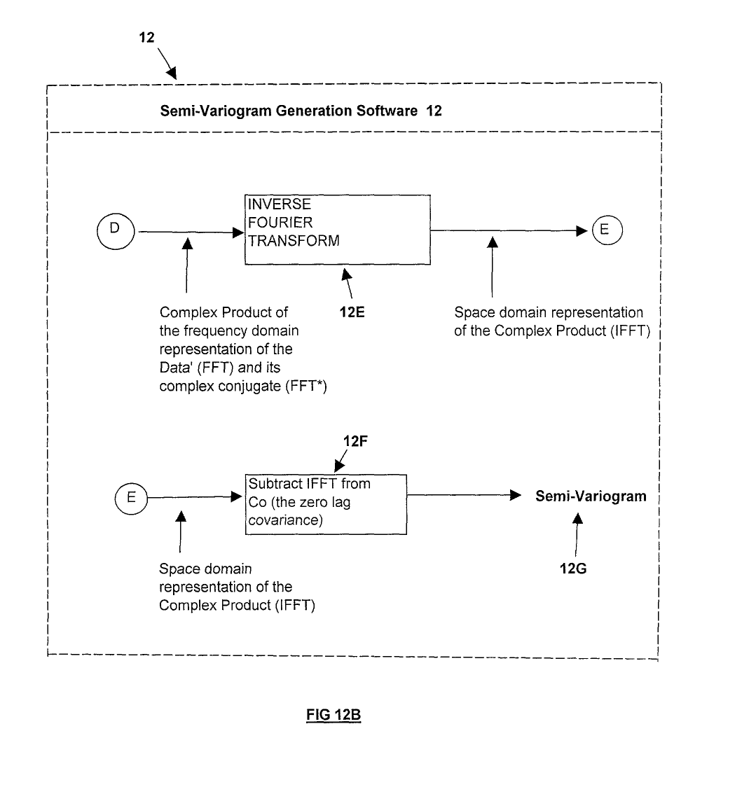

Referring to FIG. 10, as will be seen in connection with FIGS. 11 and 12A, ‘any spatial data’ 17 is provided as input data to the workstation 15, and any spatial data 17 can be used during the execution of the Semi-Variogram Generation Software 12 of FIG. 9. FIG. 10 provides an example of that spatial data. It should be emphasized that any spatial data can be used during the execution of the Semi-Variogram Generation Software 12 for generating a Semi-Variogram. The spatial data illustrated in FIG. 10 is only one example of that spatial data 17. In FIG. 10, the spatial data is illustrated in an ‘x-y coordinate system’: different elements of such data are illustrated by an ‘X’, each ‘X’ is separated by a particular distance, and each ‘X’ has a particular amplitude, such as amplitudes V1 through V5. A cube of earth formation 22 has a time slice or horizon slice 24 disposed therethrough, and either a plurality of wellbores having a corresponding plurality of well-logs 26 associated therewith or a plurality of seismic traces 26 pass through the time slice or horizon slice 24. On the time slice/horizon slice 24, a point ‘X’ represents a location on the time slice/horizon slice 24 where each wellbore/well-log 26 or each seismic trace 26 intersects the time slice/horizon slice 24. At each point ‘X’ on the time slice/horizon slice 24, a particular amplitude is associated with each seismic trace 26, and/or an amplitude is associated with each well-log 26 for each wellbore. For example, at the first point ‘X’, amplitude ‘V1’ is associated with the first point ‘X’, and, at the second point ‘X’, amplitude ‘V2’ is associated with the second point ‘X’. In FIG. 10, the time slice/horizon slice 24 is shown in greater detail. On that time slice/horizon slice 24, a plurality of amplitudes V1, V2, V3, V4, and V5 are associated with a corresponding plurality of points ‘X’ on the time slice/horizon slice 24. In addition, in FIG. 10, those same plurality of amplitudes V1, V2, V3, V4, and V5 can be seen on the y-axis of the ‘x-y coordinate system’ associated with the aforementioned ‘any spatial data’ 17.

Referring to FIG. 1 1, a block diagram of the Semi-Variogram Generation Software 12 is illustrated. In FIG. 11, the Semi-Variogram Generation Software 12 includes the following basic method steps:

1. After receiving the aforementioned ‘any spatial data’ 17, Fourier Transform the Spatial Data 17, Block 12A.

2. Remove the DC component thereby producing FFT, block 12B.

3. Compute the Complex Conjugate of FFT thereby producing FFT*, block 12C.

4. Complex multiply FFT and FFT* thereby producing a Complex Product, block 12D.

5. Inverse Fourier Transform the Complex Product thereby producing (IFFT), block 12E.

6. Subtract (IFFT) from Co, the zero lag covariance, block 12F.

7. A ‘result’ is now generated, and that ‘result’ is a Semi-Variogram of the types illustrated in FIGS. 1 through 3 of the drawings.

The method steps of the Semi-Variogram Generation Software 12 of FIG. 1 are illustrated again, in greater detail, in FIGS. 12A and 12B of the drawings.

Referring to FIGS. 12A and 12B, a more detailed construction of the Semi-Variogram Generation software 12 of the present invention, of FIGS. 9 and 11, is illustrated.

In FIG. 12A, any spatial data 17 can be used in connection with the Semi-Variogram Generation software 12 of the present invention for generating a Semi-Variogram. The spatial data block 17 of FIG. 12A generates ‘spatial data in the space domain’. In FIG. 12A, block 12A, the first step of the Semi-Variogram Generation software 12 is to Fourier Transform the ‘spatial data in the space domain’. This step involves computing the Frequency Domain representation of the ‘spatial data in the space domain’ by taking the Fourier Transform of the ‘spatial data in the space domain’, block 12A. The output of block 12A consists of: a Frequency Domain representation of the ‘spatial data in the space domain’—here, there is a zero frequency (DC/bias) component—and the DC component is equivalent to the ‘mean’ of the ‘spatial data’. In FIG. 12A, block 12B, the next step of the Semi-Variogram Generation software 12 is to remove the DC component, block 12B. The output of block 12B consists of: the “Frequency Domain representation of the ‘spatial data’ having no DC component”; and this output is hereinafter called “FFT”, an acronym for ‘Fast Fourier Transform’. In FIG. 12A, block 12C, the FFT output of block 12B is input to block 12C. In block 12C, this step of the Semi-Variogram Generation software 12 involves computing the complex conjugate of ‘FFT’ (the Frequency Domain representation of the ‘spatial data’ having no DC component) by negating the phase. Therefore, the output of block 12C consists of: the “complex conjugate of the frequency domain representation of the ‘spatial data’.”; and this output is hereinafter called “FFT*”, an acronym for the ‘complex conjugate of the Fast Fourier Transform’. Referring back to blocks 12B and 12C, block 12B generates “FFT” and block 12C generates “FFT*”. In FIG. 12A, the “FFT” output of block 12B and the “FFT*” output of block 12C are both input to block 12D. In block 12D, this step of the Semi-Variogram Generation software 12 includes: Complex multiply FFT and FFT*. As a result, the output of block 12D consists of: the ‘complex product of, (1) the frequency domain representation of the ‘spatial data’, FFT, and (2) the complex conjugate of the frequency domain representation of the ‘spatial data’, FFT*.

In FIG. 12B, the “complex product of the frequency domain representation of the ‘spatial data’, FFT, and the complex conjugate of the frequency domain representation of the ‘spatial data’, FFT*”, which is the output of block 12D, is provided as an input to block 12E. In block 12E, this step of the Semi-Variogram Generation software 12 includes: taking the Inverse Fourier Transform of the aforementioned “complex product of the frequency domain representation of the spatial data, FFT, and the complex conjugate of the frequency domain representation of the spatial data, FFT*”. The output of block 12E consists of: the space domain representation of the complex product; and this output is hereinafter called “IFFT”. The ‘IFFT’ output from block 12E (representing the space domain representation of the complex product of FFT and FFT*) is provided as an input to block 12F. In block 12F, this step of the Semi-Variogram Generation software 12 includes: subtract IFFT from Co, where Co is the zero lag covariance. As a result of the execution of block 12F in FIG. 12B, when JFFT is subtracted from Co (the zero lag covariance), a ‘Semi-Variogram’ is generated. See step 12G in FIG. 12B. The following five (5) additional references are incorporated by reference into this specification:

(1) A. G. Journel, Fundamentals of Geostatistics in Five Lessons, Short Course in Geology, vol 8, 40 pp., AGU, Washington, D.C. 1989

(2) Clayton V. Deutsch & Andre G.Journel, GSLib—Geostatistical Software Library and User's Guide, second edition, Oxford University Press, New York, N.Y. 1998

(3) Alan V. Oppenheim & Ronald W. Schafer, Digital signal Processing, Prentice-Hall, Inc., Englewood Cliffs N.J., ©1975

(4) A. Papoulis, The Fourier Integral and its Applications, McGraw-Hill, N.Y. 1992

(5) D. G. Krige, A review of the developments of geostatistics in South Africa, Proceedings of the NATO advanced study institute, Rome, Oct. 13-25, 1975, pp 279-311

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

I claim:

1. A method of generating a Semi-Variogram, comprising the steps of:
(a) receiving spatial data in a space domain;
(b) taking a Fourier Transform of said spatial data, and
(c) generating a Semi-Variogram in response to the taking step.

2. The method of claim 1, wherein, following the taking step, a frequency domain representation of the spatial data is generated including a DC component or mean of the spatial data, and wherein the generating step (c) comprises the step of:
(c1) removing said DC component thereby generating a frequency domain representation of the spatial data with zero mean (FFT).

3. The method of claim 2, wherein the generating step (c) further comprises the step of:
(c2) computing a complex conjugate of said FFT thereby producing FFT*.

4. The method of claim 3, wherein the generating step (c) further comprises the step of:
(c3) complex multiplying said FFT and said FFT* thereby producing a complex product.

5. The method of claim 4, wherein the generating step (c) further comprises the step of:
(c4) taking an inverse Fourier Transform of said complex product thereby generating a space domain representation of the complex product (IFFT).

6. The method of claim 5, wherein the generating step (c) further comprises the step of:
(c5) subtracting said IFFT from a zero lag covariance thereby generating said Semi-Variogram.

7. A program storage device adapted for storing instructions, said instructions adapted to be executed by a processor, said instructions when executed by said processor conducting a method comprising the steps of:
(a) receiving spatial data in a space domain;
(b) taking a Fourier Transform of said spatial data, and
(c) generating a Semi-Variogram in response to the taking step.

8. The program storage device of claim 7, wherein, following the taking step, a frequency domain representation of the spatial data is generated including a DC component or mean of the spatial data, and wherein the generating step (c) comprises the step of:
(c1) removing said DC component thereby generating a frequency domain representation of the spatial data with zero mean (FFT).

9. The program storage device of claim 8, wherein the generating step (c) further comprises the step of:
(c2) computing a complex conjugate of said FFT thereby producing FFT*.

10. The program storage device of claim 9, wherein the generating step (c) further comprises the step of:
(c3) complex multiplying said FFT and said FFT* thereby producing a complex product.

11. The program storage device of claim 10, wherein the generating step (c) further comprises the step of:
(c4) taking an inverse Fourier Transform of said complex product thereby generating a space domain representation of the complex product (IFFT).

12. The program storage device of claim 11, wherein the generating step (c) further comprises the step of:
(c5) subtracting said IFFT from a zero lag covariance thereby generating said Semi-Variogram.

13. An apparatus responsive to a set of spatial data in a space domain adapted for generating a Semi-Variogram, comprising:
first means for receiving said spatial data in a space domain;
second means for taking a Fourier Transform of said spatial data, and
third means for generating a Semi-Variogram in response to said taking of said Fourier Transform of said spatial data by said second means.

14. The apparatus of claim 13, wherein said second means takes said Fourier Transform of said spatial data and, responsive thereto, generates a frequency domain representation of said spatial data including a DC component or mean of said spatial data, and wherein said third means comprises:
means for removing said DC component thereby generating a frequency domain representation of the spatial data with zero mean (FFT).

15. The apparatus of claim 14, wherein said third means further comprises:
means for computing a complex conjugate of said FFT thereby producing FFT*.

16. The apparatus of claim 15, wherein said third means further comprises:
means for complex multiplying said FFT and said FFT* thereby producing a complex product.

17. The apparatus of claim 16, wherein said third means further comprises:
means for taking an inverse Fourier Transform of said complex product thereby generating a space domain representation of the complex product (IFFT).

18. The apparatus of claim 17, wherein said third means further comprises: means for subtracting said IFFT from a zero lag covariance thereby generating said Semi-Variogram.
